(19) United States
(12) Patent Application Publication
(10) Pub. No.: US 2021/0357055 A1
(43) Pub. Date: Nov. 18, 2021

(54) TOUCH DISPLAY PANEL AND DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Min FU, Shenzhen, Guangdong (CN); Yongfeng LIU, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/966,926

(22) PCT Filed: Jun. 3, 2020
(86) PCT No.: PCT/CN2020/094155

§ 371 Date: Aug. 3, 2020

(30) Foreign Application Priority Data
May 13, 2020 (CN) 202010403297.1

(51) Int. Cl. G06F 3/041; G06F 3/044

(52) U.S. Cl. CPC G06F 3/0412; G06F 2203/04107; G06F 3/0446; G06F 3/0445

(57) ABSTRACT

A touch display panel is provided. The touch display panel includes an array substrate, a color filter substrate, a glass cover plate, first touch electrodes, and second touch electrodes. The color filter substrate is disposed opposite to the array substrate, the glass cover plate is arranged on a side of the array substrate away from the color filter substrate, the first touch electrodes are disposed inside the array substrate, and the second touch electrodes are disposed between the array substrate and the glass cover plate.

### FIELD OF INVENTION

The present disclosure relates to the field of display technologies, and particularly relates to a touch display panel and a display device.

### BACKGROUND OF INVENTION

In order to realize integration of a touch display panel and a liquid crystal display (LCD) panel, a touch function of the touch display panel is generally realized through on-cell and in-cell touch display technologies. Among them, the in-cell touch display technology is widely used because of its high penetration, high-resolution, and low costs.

At present, the in-cell touch display technology generally refers to touch electrodes disposed on a color filter substrate. However, in such a configuration, a touch signal is easily interfered by a Vcom signal, thereby leading to a poor touch effect of the touch display panel.

### Technical Problems

At present, the in-cell touch display technology generally refers to touch electrodes y disposed on a color filter substrate. However, in such a configuration, a touch signal is easily interfered by a Vcom signal, thereby leading to a poor touch effect of the touch display panel.

### Technical Solutions

Embodiments of the present disclosure provide a touch display panel and a display device, which can improve a touch effect of the touch display panel.

In a first aspect, an embodiment of the present disclosure provides a touch display panel, including:
an array substrate;
a color filter substrate disposed opposite to the array substrate;
a glass cover plate arranged on a side of the array substrate away from the color filter substrate;
first touch electrodes disposed inside the array substrate; and
second touch electrodes disposed between the array substrate and the glass cover plate.

In the touch display panel provided by an embodiment of the present disclosure, the array substrate comprises an array layer, a passivation layer, and a pixel electrode layer, and the first touch electrodes are disposed between the array layer and the passivation layer.

In the touch display panel provided by an embodiment of the present disclosure, the touch display panel further comprises a shielding layer disposed on the first touch electrodes and the array layer.

In the touch display panel provided by an embodiment of the present disclosure, the shielding layer is composed of shielding electrodes and is configured to shield electric signals at a side of the pixel electrode layer.

In the touch display panel provided by an embodiment of the present disclosure, the first touch electrodes extend along a first direction, the second touch electrodes extend along a second direction, and the first direction crosses with the second direction.

In the touch display panel provided by an embodiment of the present disclosure, an angle between the first direction and the second direction is 90°.

In the touch display panel provided by an embodiment of the present disclosure, the first touch electrodes and the second touch electrodes are arranged in a grid shape with equal intervals.

In the touch display panel provided by an embodiment of the present disclosure, the first touch electrodes are driving electrodes, and the second touch electrodes are sensing electrodes; alternatively

the first touch electrodes are sensing electrodes, and the second touch electrode are driving electrodes.

In the touch display panel provided by an embodiment of the present disclosure, the first touch electrodes and the second touch electrodes are metal electrodes or transparent electrodes.

In the touch display panel provided by an embodiment of the present disclosure, the first touch electrodes and the second touch electrodes are strip touch electrodes or diamond touch electrodes.

In a second aspect, the present disclosure provides a display device, including:
an array substrate;
a color filter substrate disposed opposite to the array substrate;
a glass cover plate arranged on a side of the array substrate away from the color filter substrate;
first touch electrodes disposed inside the array substrate; and
second touch electrodes disposed between the array substrate and the glass cover plate.

In the display device provided by an embodiment of the present disclosure, the array substrate comprises an array layer, a passivation layer, and a pixel electrode layer, and the first touch electrodes are disposed between the array layer and the passivation layer.

In the display device provided by an embodiment of the present disclosure, the touch display panel further comprises a shielding layer disposed on the first touch electrodes and the array layer.

In the display device provided by an embodiment of the present disclosure, the shielding layer is composed of shielding electrodes and is configured to shield electric signals at a side of the pixel electrode layer.

In the display device provided by an embodiment of the present disclosure, the first touch electrodes extend along a first direction, the second touch electrodes extend along a second direction, and the first direction crosses with the second direction.

In the display device provided by an embodiment of the present disclosure, an angle between the first direction and the second direction is 90°.

In the display device provided by an embodiment of the present disclosure, the first touch electrodes and the second touch electrodes are arranged in a grid shape with equal intervals.

In the display device provided by an embodiment of the present disclosure, the first touch electrodes are driving electrodes, and the second touch electrodes are sensing electrodes; alternatively
the first touch electrodes are sensing electrodes, and the second touch electrode are driving electrodes.

In the display device provided by an embodiment of the present disclosure, the first touch electrodes and the second touch electrodes are metal electrodes or transparent electrodes.

In the display device provided by an embodiment of the present disclosure, the first touch electrodes and the second touch electrodes are strip touch electrodes or diamond touch electrodes.

### BENEFICIAL EFFECTS

The present disclosure provides a touch display panel including an array substrate, a color filter substrate, a glass cover plate, first touch electrodes, and second touch electrodes. Wherein, the color filter substrate is disposed opposite to the array substrate, the glass cover plate is arranged on a side of the array substrate away from the color filter substrate, the first touch electrodes are disposed inside the array substrate, and the second touch electrodes are disposed between the array substrate and the glass cover plate. This solution can improve a touch effect of the touch display panel.

### DESCRIPTION OF DRAWINGS

In order to more clearly explain the technical solution in the embodiment of the present disclosure, the drawings needed in the description of the embodiment will be briefly introduced below. Obviously, the accompanying figures described below are only part of the embodiments of the present disclosure. For those skilled in the art, other drawings can be obtained based on these drawings any creative work.

FIG. 1 is a structural schematic view of a touch display panel according to an embodiment of the present disclosure.

FIG. 2 is another structural schematic view of a touch display panel according to an embodiment of the present disclosure.

FIG. 3 is another structural schematic view of a touch display panel according to an embodiment of the present disclosure.

FIG. 4 is a structural schematic view of touch electrodes according to an embodiment of the present disclosure.

FIG. 5 is another structural schematic view of touch electrodes according to an embodiment of the present disclosure.

### DETAILED DESCRIPTION OF EMBODIMENTS

The technical solutions in the embodiments of the present disclosure will be described clearly and completely with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative work fall into protection scope of the present disclosure.

The embodiments of the present disclosure provide a touch display panel and a display device, which are described in detail below.

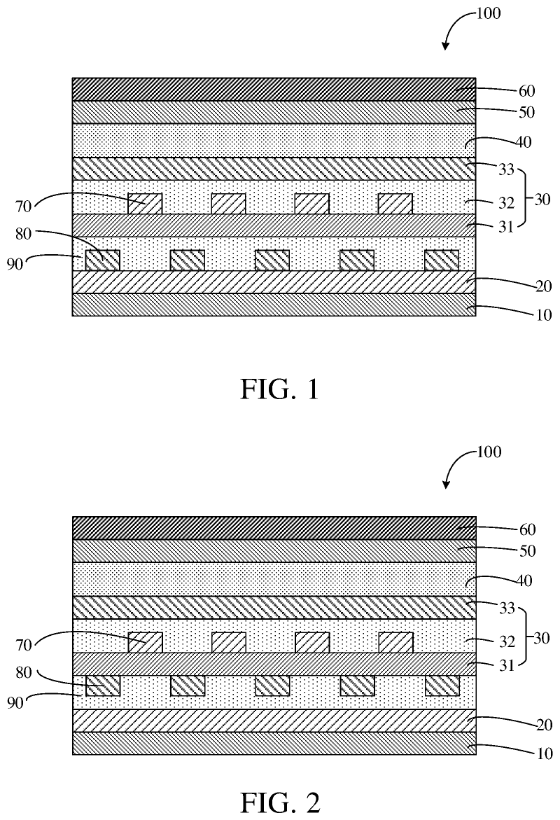

Referring to FIG. 1, it is a schematic view of a touch display panel according to the embodiment of the present disclosure. The touch display panel 100 includes a first polarizer 10, a glass cover plate 20, an array substrate 30, a liquid crystal layer 40, a color filter substrate 50, a second polarizer 60, first touch electrodes 70, and second touch electrodes 80.

Wherein, the array substrate 30 and the color filter substrate 50 are disposed oppositely. The glass cover plate 20 is arranged on a side of the array substrate 30 away from the color filter substrate 50. The first touch electrodes 70 are disposed inside the array substrate 30. The second touch electrodes 80 are disposed between the array substrate 30 and the glass cover plate 20. The first polarizer 10 is arranged on a side of the glass cover plate 30 away from the array substrate 30. The liquid crystal layer 40 is disposed between the array substrate 30 and the color filter substrate 50, and the second polarizer 60 is arranged on a side of the color filter substrate 50 away from the array substrate 30.

Wherein, the array substrate 30 includes an array layer 31, a passivation layer 32, and a pixel electrode layer 33. It can be understood that the array layer 31 includes a gate layer, a source drain layer, a buffer layer, an active layer, an insulating layer, and other film structures.

In some embodiments, the first touch electrodes 70 are disposed between the array layer 31 and the passivation layer 32. Wherein, the passivation layer 32 is an inorganic material layer, which can insulate the first touch electrodes 70 from the pixel electrode layer 33, thereby relieving a touch signal of the first touch electrodes 70 of an influence of electric signals on a side of the pixel electrode layer 33.

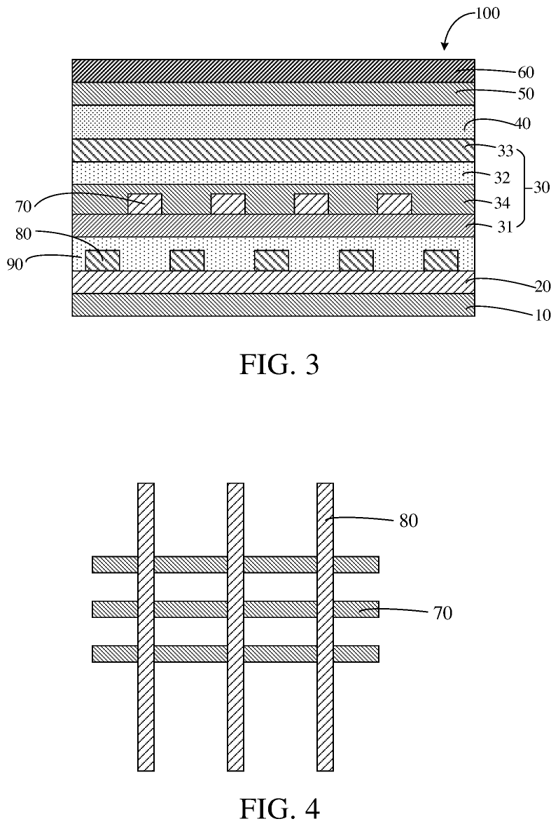

In some embodiments, in order to further relieve the touch signal of the first touch electrodes 70 of the influence of electric signals on the side of the pixel electrode layer 33, as shown in FIG. 3, a shielding layer 34 may be arranged on the first touch electrodes 70 and the array layer 31. The shielding layer 34 may be composed of shielding electrodes and is configured to shield the electric signals on the side of the pixel electrode layer 33.

It should be noted that in the description of the present disclosure, the terms “first” and “second” are only used for the purpose of description and can't be understood as indicating or implying relative importance or quantity of technical features. Thus, the features defined as “first” and “second” may explicitly or implicitly include one or more given features.

In some embodiments, a touch insulating layer 90 may also be arranged between the array substrate 30 and the glass cover plate 20. A material of the touch insulating layer 90 may include an optical glue (such as optically clear adhesive (OCA)) or a passivation material (such as silicon nitride).

It can be understood that the second touch electrodes 80 may be disposed on a side of the glass cover plate 20 adjacent to the array substrate 30 or on the side of the array substrate 30 adjacent to the glass substrate 20. For details, referring to FIG. 1 or FIG. 2.

It should be noted that in the embodiment of the present disclosure, when the second touch electrodes 80 is arranged on the side of the glass cover plate 20 adjacent to the array substrate 30, the material of the touch insulating layer 90 is the optical glue. When the second touch electrodes 80 is arranged on the side of the array substrate 30 adjacent to the glass substrate 20, the material of the touch insulating layer 90 is the passivation material.

It can be understood that when the second touch electrodes 80 is arranged on the side of the array substrate 30 adjacent to the glass substrate 20, because the second touch electrodes 80 is disposed on the array substrate 30, a passivation material layer can be directly formed on the second touch electrodes 80 through a panel process to protect the second touch electrodes 80. On the other way, when the second touch electrodes 80 is arranged on the side of the glass cover plate 20 adjacent to the array substrate 30, because the second touch electrodes 80 is disposed on the glass cover plate 20, the panel process cannot be used to directly from a passivation material layer on the second touch electrodes 80 for protection.

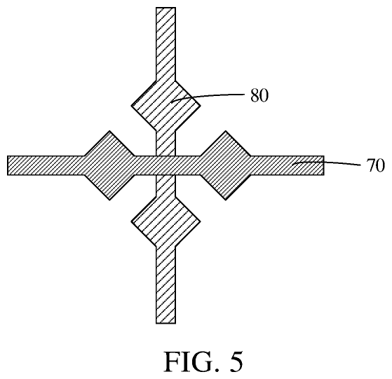

In some embodiments, as shown in FIG. 4 or FIG. 5. The first touch electrodes 70 and the second touch electrodes 80 are strip touch electrodes or diamond touch electrodes. It should be noted that the first touch electrodes 70 may be a plurality of parallel strip touch electrodes or diamond touch electrodes extending along a first direction. The second touch electrodes 80 may be a plurality of parallel strip touch electrodes or diamond touch electrodes extending along a second direction. The first direction crosses with the second direction. Preferably, an angle between the first direction and the second direction is 90°.

It should be noted that in the embodiment of the present disclosure, because the first touch electrodes 70 and the second touch electrodes 80 are arranged in a grid shape with equal intervals, when the touch display panel 100 is touched, a point of touch can be determined with greater accuracy, thereby improving the touch effect of the touch display panel 100.

In some embodiments, the first touch electrodes 70 and the second touch electrodes 80 may be driving electrodes or sensing electrodes. It can be understood that when the first touch electrodes 70 refer to the driving electrodes, the second touch electrodes 80 refer to the sensing electrodes. When the first touch electrodes 70 refer to the sensing electrodes, the second touch electrodes 80 refer to the driving electrodes. Wherein, the first touch electrodes 70 and the second touch electrodes 80 are metal electrodes or transparent electrodes.

For the above description, in the touch display panel provided in the embodiment of the present disclosure, the first touch electrodes 70 are disposed inside the array substrate 30, the second touch electrodes 80 are disposed between the array substrate and the glass cover plate, and displaying and touching are performed from the side of the array substrate 30, so as to solve the problem that the touch signal is interfered by a Vcom signal due to the first touch electrodes 70 and the second touch electrodes 80 being disposed on the color filter substrate 31. That is, in this solution, the first touch electrodes 70 and the second touch electrodes 80 disclosure can be disposed on the side of the array substrate 30 to improve touch effect of the touch display panel 100.

The embodiment of the present disclosure also provides a display device. The display device may include any touch display panel in the above embodiments. It should be noted that the display device can be a mobile phone, a tablet computer, and other electronic devices.

In the above embodiments, the description of each embodiment has its own emphasis. For the part not detailed in one embodiment, please refer to the relevant description of other embodiments.

The above content is detail description for a touch display panel and a display device provided by the embodiment of the present disclosure. In this paper, specific examples are applied to explain the principle and mode of implementation of the application, and the description of the above embodiments are only used for helping understand technical scheme and core idea of the application. A person of ordinary skill in the art should understand that the technical solutions recorded in the above-mentioned embodiments can be modified, or some of the technical features therein can be replaced equivalently. However, such modification or replacement does not make the essence of the corresponding technical solutions out of the scope of the technical solutions of the embodiments of the present application.

1. A touch display panel, comprising:
an array substrate;
a color filter substrate disposed opposite to the array substrate;
a glass cover plate arranged at a side of the array substrate away from the color filter substrate;
first touch electrodes disposed inside the array substrate; and
second touch electrodes disposed between the array substrate and the glass cover plate and disposed at one side of the array substrate away from the color filter substrate;
wherein the second touch electrodes are disposed on a side of the glass cover plate adjacent to the array substrate or on a side of the array substrate adjacent to the glass cover plate;
the array substrate comprises an array layer, a passivation layer, and a pixel electrode layer, and the first touch electrodes are disposed between the array layer and the passivation layer; and
a shielding layer is disposed on the first touch electrodes and the array layer.

2-3. (canceled)

4. The touch display panel in claim 1, wherein the shielding layer is composed of shielding electrodes and is configured to shield electric signals at a side of the pixel electrode layer.

5. The touch display panel in claim 1, wherein the first touch electrodes extend along a first direction, the second touch electrodes extend along a second direction, and the first direction crosses with the second direction.

6. The touch display panel in claim 5, wherein an angle between the first direction and the second direction is 90°.

7. The touch display panel in claim 6, wherein the first touch electrodes and the second touch electrodes are arranged in a grid shape with equal intervals.

8. The touch display panel in claim 1, wherein the first touch electrodes are driving electrodes, and the second touch electrodes are sensing electrodes; alternatively,
the first touch electrodes are sensing electrodes, and the second touch electrode are driving electrodes.

9. The touch display panel in claim 1, wherein the first touch electrodes and the second touch electrodes are metal electrodes or transparent electrodes.

10. The touch display panel in claim 1, wherein the first touch electrodes and the second touch electrodes are strip-shaped touch electrodes or diamond-shaped touch electrodes.

11. A display device, comprising:
an array substrate;
a color filter substrate disposed opposite to the array substrate;
a glass cover plate arranged at a side of the array substrate away from the color filter substrate;
first touch electrodes disposed inside the array substrate; and
second touch electrodes disposed between the array substrate and the glass cover plate and disposed at one side of the array substrate away from the color filter substrate;
wherein the second touch electrodes are disposed on a side of the glass cover plate adjacent to the array substrate or on a side of the array substrate adjacent to the glass cover plate;
the array substrate comprises an array layer, a passivation layer, and a pixel electrode layer, and the first touch electrodes are disposed between the array layer and the passivation layer; and
a shielding layer is disposed on the first touch electrodes and the array layer.

12-13. (canceled)

14. The display device in claim 11, wherein the shielding layer is composed of shielding electrodes and is configured to shield electric signals at a side of the pixel electrode layer.

15. The display device in claim 11, wherein the first touch electrodes extend along a first direction, the second touch electrodes extend along a second direction, and the first direction crosses with the second direction.

16. The display device in claim 15, wherein an angle between the first direction and the second direction is 90°.

17. The display device in claim 16, wherein the first touch electrodes and the second touch electrodes are arranged in a grid shape with equal intervals.

18. The display device in claim 11, wherein the first touch electrodes are driving electrodes, and the second touch electrodes are sensing electrodes; alternatively,
the first touch electrodes are sensing electrodes, and the second touch electrode are driving electrodes.

19. The display device in claim 11, wherein the first touch electrodes and the second touch electrodes are metal electrodes or transparent electrodes.

20. The display device in claim 11, wherein the first touch electrodes and the second touch electrodes are strip-shaped touch electrodes or diamond-shaped touch electrodes.
